(19) United States
(12) Patent Application Publication
(10) Pub. No.: US 2010/0134305 A1
(43) Pub. Date: Jun. 3, 2010

(54) INTELLIGENT ADAPTIVE ENERGY MANAGEMENT SYSTEM AND METHOD FOR A WIRELESS MOBILE DEVICE

(75) Inventors: Cui Lu, Guangzhou (CN); Pengcheng Zou, Beijing (CN); Dallas Lee Nash, II, Ridgeland, MS (US)

Correspondence Address: Nyemaster, Goode, West, Hansell & O''Brien, P.C., 625 First Street SE, Suite 400, Cedar Rapids, IA, 52401, US

(73) Assignee: VBI 2000, LLC, Bartonville, TX (US)

(21) Appl. No.: 12/369,130

(22) Filed: Feb. 11, 2009

(30) Foreign Application Priority Data
Nov. 29, 2008 (CN) 2008203029355

(51) Int. Cl. G08B 21/00; H02J 7/00; G06F 1/26

(52) U.S. Cl. 340/636.13; 320/128; 320/135; 320/134; 340/636.1; 340/636.15; 713/300

(57) ABSTRACT

An intelligent adaptive energy management system and method for an electronic device such as a cell phone or laptop computer. The system comprises at least two batteries that work cooperatively. The system includes multiple features that may be used alone or in combination. One feature includes one or more sensors capable of measuring various characteristics of the battery cells such as temperature, voltage, and shape deformation. The sensors communicate the measured data to a control module which may control cell charging, cell discharging, cell balancing, and/or terminating the use of one or more of the cells. A second feature is to enhance the scalability of the batteries by making the battery cells logically and/or physically removable and configurable so that the capacity of the batteries can be scaled on demand. A third feature is to provide intelligent charging and discharging methodologies. One alternate discharge method discharges the cells intelligently using measured rotational turns. This process allows every battery cell to recover energy due to chemical elasticity during its idle phase and, therefore, output more energy. A forth feature of this invention is to allow the alternate discharging method to make possible hot plug of battery cells. Another feature is to provide a communication mechanism between a secondary battery and the powered mobile device. Through this communication, the secondary battery can be managed based on the primary battery status and the power requirements (profile) of the electronic device. Another feature is to provide a method to store historical data that will facilitate better performing energy management algorithms that are device use specific. Circuitry, firmware, and programmable software may be used to implement and control the above systems and methodologies.

### BACKGROUND

This application claims priority to Chinese patent application serial number 2008203029355 filed on Nov. 29, 2008, the disclosure of which is hereby incorporated by reference.

With the popularity of a new generation of electronic powered devices such as smart phones, the cell phone is changing from a voice communication tool into a multi-function mobile device providing functions such as gaming, navigation, office, data exchange, etc. More and more power is required to drive all these features and, because of this, most smart phones can only remain in standby mode for one day and actually run less than 6 hours in communication modes. With the popularity of this new generation of mobile devices, the battery becomes a significant bottleneck for the effective general usage and the facilitation of true mobility planned for these devices.

To answer the increasing demands for battery power, several solutions are currently available. One solution is for the device to have an extra internal battery. A second solution is that the internal battery could have a larger capacity. A third solution is to replace another device (DVD RW) with a second battery in a device equipped with a multi-function bay. A forth solution is that the user could carry an external battery or external battery back.

The first three options listed above have several problems. First, although they can be used to provide additional power, they normally require recharge using a separate AC battery charger made for the mobile device to recharge the battery. Another problem is that the internal battery can be hard to install (in the case of smart phones) and the device needs to be turned off to install the extra internal battery. Another problem is that the internal battery can only be used for certain corresponding mobile devices and cannot be reused by other mobile devices. Further, for some types of smart phones, the user cannot replace the internal battery, instead, the user must send the device back to the vendor to change the battery. Lastly, the capacity of an internal battery is fixed so that the user cannot increase or decrease the battery capacity.

The forth option listed above also has several problems. A traditional “dumb” external battery provides power based on the pre-defined voltage and power requirement of the powered device. The external battery is connected with the powered device via the power cable and it is charged using the charger designed specifically for it. Further, compared with the internal battery, the external battery adds extra weight and can be hard to carry and use. Another problem is that unlike the internal battery, the traditional external battery is treated the same as the AC power adapter by the powered device, so the powered device cannot enter the power saving power management mode when it is powered by the external battery. Instead, the high performance mode is used which is not energy-efficient. Another problem is that the capacity of the external battery is fixed and the user cannot increase or decrease the battery capacity and the related weight of the battery when necessary or desired. Additionally, the battery cell can only be charged and recharged according to the prearranged number of cycles. If a single battery cell wears out, the whole external battery or battery system becomes useless.

### SUMMARY

The present invention comprises an intelligent adaptive energy management system and method for an electronic device such as a cell phone or laptop computer. The system comprises at least two batteries that work cooperatively. The system includes multiple features that may be used alone or in combination. One feature includes one or more sensors capable of measuring various characteristics of the battery cells such as temperature, voltage, and shape deformation. The sensors communicate the measured data to a control module which may control cell charging, cell discharging, cell balancing, and/or terminating the use of one or more of the cells. A second feature of this invention is to enhance the scalability of the batteries by making the battery cells logically and/or physically removable and configurable so that the capacity of the batteries can be scaled on demand. A third feature of this invention is to provide intelligent charging and discharging methodologies. One alternate discharge method discharges the cells intelligently using measured rotational turns. This process allows every battery cell to recover energy due to chemical elasticity during its idle phase and, therefore, output more energy. A forth feature of this invention is to allow the alternate discharging method to make possible hot plug of battery cells. Another feature of this invention is to provide a communication mechanism between a secondary battery and the powered mobile device. Through this communication, the secondary battery can be managed based on the primary battery status and the power requirements (profile) of the electronic device. Another feature of this invention is to provide a method to store historical data that will facilitate better performing energy management algorithms that are device use specific. Circuitry, firmware, and programmable software may be used to implement and control the above systems and methodologies.

### BRIEF DESCRIPTION OF THE DRAWINGS

FIG. 1 is a block diagram of the intelligent adaptive energy management system for a portable electronic device;

FIG. 2 is a block diagram of the software architecture;

FIG. 3 is a block diagram of the portable device and energy management system interface;

FIG. 4 is a flow chart of an embodiment;

FIG. 5 is an embodiment showing a two-cell implementation of the invention;

FIG. 6 is an embodiment of the protective case;

FIG. 7 is an embodiment of the energy management system used with Apple Inc.'s IPHONE product (IPHONE is a registered trademark of Apple, Inc);

FIG. 8 shows the physical connection of an embodiment with an Apple Inc.'s IPHONE product (IPHONE is a registered trademark of Apple, Inc);

FIG. 9 is a flow chart of the cell pool update process;

FIG. 10a is a graph showing the galvanostatic method used to measure the battery status input galvanostatic current pulse;

FIG. 10b is a graph showing the galvanostatic method used to measure the battery status response voltage change;

FIG. 11 is a graph showing a charging pulse wave form;

FIG. 12 is a graph showing the discharging logic with short-term charging current pulse;

FIG. 13 is a circuit diagram showing a deformation sensor; and

FIG. 14 is a flow chart of the discharging method applied to multiple cells.

### DETAILED DESCRIPTION

This invention is an intelligent adaptive energy management system and method adapted to increase optimal energy output, maximize cell life, and enhance the safety of an energy cell or group of cells. The system is adapted to be used with a portable or mobile powered electronic device 116 such as a cell phone, laptop computer, or camera. The system requires at least two energy sources that work cooperatively. This specification describes the invention as using battery cells as the energy source, however, any suitable energy source may be used including fuel cells.

The system includes multiple features that may be used alone or in combination. The features may be used in one of several embodiments. In the external battery embodiment, the electronic device 116 has at least one primary (internal) battery cell (not shown) to allow the device 116 to be portable. This primary cell typically comes with the electronic device when it is purchased. The system comprises at least one secondary (external) battery 102 that works cooperatively with the electronic device's 116 primary battery. In this embodiment, the secondary battery 102 is located outside the housing of the electronic device because the system is typically an aftermarket product that is sold separately from the electronic device.

In an internal battery embodiment, at least two batteries are located inside the housing of the electronic device. In this embodiment, the system is built into the electronic device at the time of purchase. The following system and methods apply to either of these embodiments except where specifically limited to one or the other.

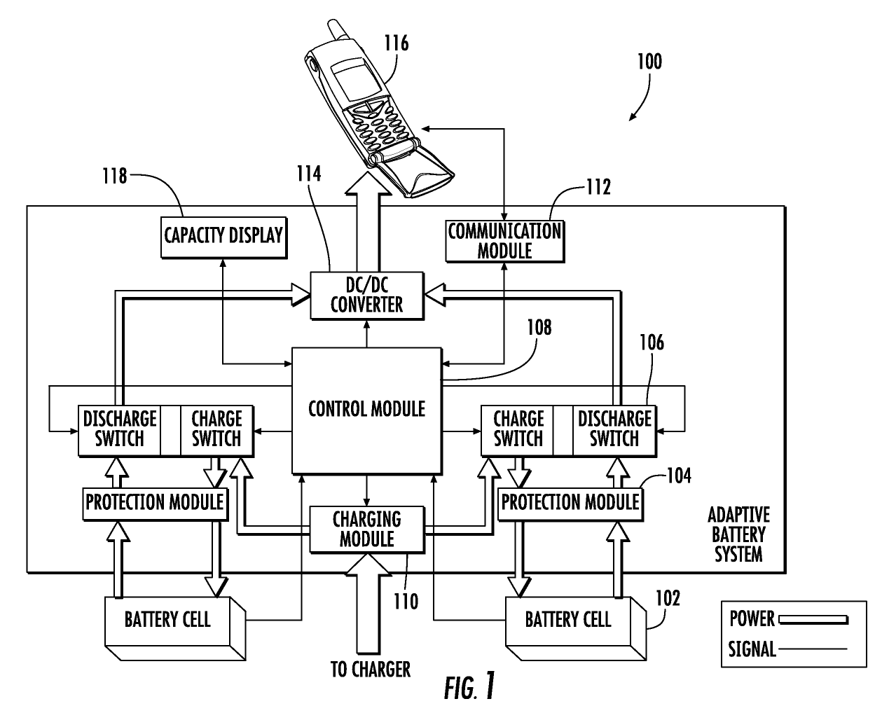

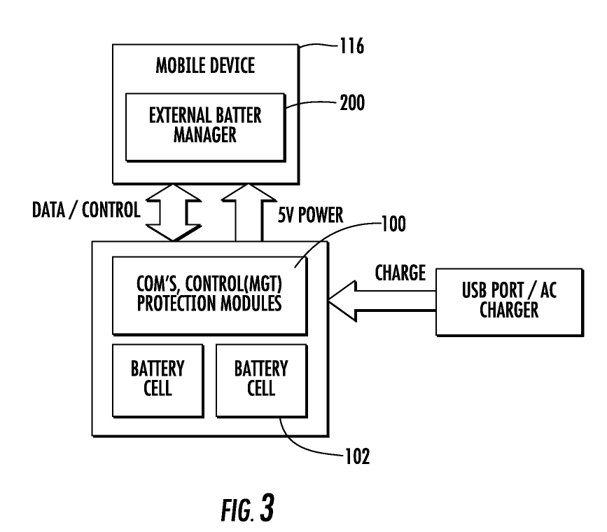

FIGS. 1 and 3 show the general components of the system. FIG. 1 is a block diagram of one embodiment of the adaptive energy management system 100 showing how the various components interact. As shown, the invention includes a control module 108 which acts as the brain of the adaptive energy management system 100. The control module controls DC/DC voltage converter 114 and the charge/discharge switch 106 to generate the required output power (for example, the proper voltage output power to an electronic device 116). The control module 108 also controls the rate at which the cells are charged externally via the charging module 110. The charging module 110 may be combined with the electronic device's 116 standard wall charger or a normal USB port to provide a charge to the primary and secondary batteries 102. The control module 108 may also be adapted to receive cell condition data from the protection module 104.

One feature of the invention relates to a protection module 104 that monitors the primary and/or secondary battery cells 102 and shuts down or isolates the cells if it is determined that one or more of the monitored values are outside of a predetermined range. The protection module 104 may be included as part of the control module 108 and include its circuit and firmware. Alternately, the protection module 104 may be a standalone unit. The control module 108 is in communication with the protection module 104 and stands ready to send an alert signal to the protection module 104 in response to a change in condition of the cell(s) 102 detected by various sensors. In some embodiments, there can be more than one protection module 104, one for each cell 102 (as shown in FIG. 1). Further, although this feature is described in terms of the protection module's 104 interaction with the secondary cells 102, it should be noted that the protection module 104 may also interact with and monitor the electronic device's 116 primary battery cells.

The protection module 104 uses sensors to measure values such as voltage, current density, temperature, tension, internal resistance, and cell shape deformation at the cell and/or battery pack level. The sensors communicate the measured data to the control module 108 which may control charging, discharging, balancing, and/or terminating the use of one or more of the cells.

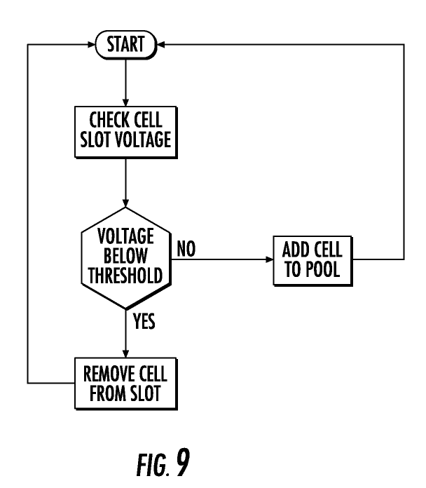

Any suitable sensor may be used to measure the various cell values. The galvanostatic pulse probing method is an example of a method used to measure the internal resistance and other electrochemistry parameters of the battery cell. A galvanostatic pulse is periodically injected into the battery by protection module 104 and the response is measured and the result is stored and analyzed by the control unit 507. An example of the input and response curve is shown in FIGS. 10a and 10b respectively. As shown in FIG. 10b, Vₒₕₘ is immediately invoked by the constant current because of the ohmic resistance inside the battery. The ΔV has a time effect that comes from composite factors such as electrochemical reactions, charging of interfaces, and diffusion processes, etc. The ohmic resistance is measured as Vₒₕₘ/ΔI and used as a factor to reveal the material decay inside the battery cell.

In some embodiments, temperature is measured using thermistor arrays and/or discrete sensors for each battery cell, battery cell pack and/or the associated near-space environment. In one embodiment, the temperature information is considered with the parameters extracted by the galvanostatic pulse detection methodology and is used to evaluate the health condition of the battery cell. If the evaluation of the battery cell health condition warrants, the system will stop the affected battery cell(s) from supplying power, as further described below.

Chemistry failure inside the battery cell or battery cell packs sometimes causes the battery cell to bulge or change shape without significant temperature change. The bulge or deformation of the battery cell might come from crystallization or the gas generated from the internal chemical reaction. As discussed above, in some embodiments of the invention, the protection module 104 comprises a sensor adapted to detect battery cell deformation. The deformation sensor may be able to detect a problem and take action earlier than the normal temperature sensor/control and will thereby prevent further harm to the battery cell and/or the device the battery is serving.

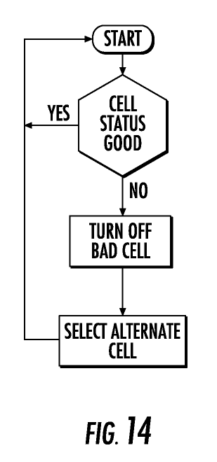

FIG. 13 shows an embodiment of the invention wherein the protection module 104 comprises deformation sensors such as strain gauge or tension sensors 700 on one or more battery cells 102 to measure the shape change at the individual cell level. For example, referring to FIG. 13, strain gauge technology is used in a Wheatstone bridge arrangement. Combined with the control module 108 and software, this smart signal monitor quickly amplifies and filters the small signals from circuit noise so the small signals can provide additional data. One or more sensors are used as the reference sensor for the system to detect change.

The control module 108 receives and manages the sensor data to develop real-time parameters that are used for battery cell management. If the measured value of any of the cell conditions (e.g. temperature, shape deformation, voltage) is outside of the acceptable range, the control module 108 will either switch off the power from the cell(s) or switch off overall power output immediately. In an alternate embodiment, the offending cell(s) is (are) given a second chance if it (they) return(s) to normality within measurable limits. In this alternate embodiment, if the offending cell(s) begins to fail a second time in the primary charge or discharge cycle, the control module 108 will mark the cell(s) in failure mode. If this happens, the failed cell(s) will not be available until the system has successfully completed an offline safety refresh cycle. If the system cannot complete an offline safety refresh cycle, an internal database to control module 108 will mark the battery cell(s) so it is no longer used to provide energy. If the marked down battery cell is part of a multi-cell implementation, it is possible that the battery cluster may remain useable but without full capacity.

In some embodiments, data collected from the sensors and processed by control module 108 is displayed to the user via the capacity display module 118. In these embodiments, the display is separate from the display on the electronic device 116. The display module 118 provides the user with information such as charge capacity of the battery cell(s) 102.

In other embodiments data (such as charge capacity) is provided to the user on the mobile device's 116 display through the communication module 112. The communications module 112 provides a two-way or interleaved communication mechanism between the adaptive energy management system 100 and the electronic device 116. In the embodiments where the system's 100 protection module 104 does not monitor the electronic device's 116 primary batteries, the communication module 112 provides information about the device's 116 primary batteries to the system's 100 control module 108. This allows the control module 108 to intelligently decide which batteries to charge and discharge, as is described in more detail below. In some embodiments, the communications module 112 also acquires, in real-time, the data and commands sent by the electronic device 116 and issues charge/discharge requests/commands of its own to the control module 108. The communications module 112 also receives the secondary battery 102 data from the control module 108, such as the remaining capacity by cell, the temperature and conformity of individual battery cells and cell status (discharging, refresh recharging, or recovery). Further, communication module 112 may send external battery 102 data to the electronic device 116 for either real-time monitoring or historical evaluation. Also, the communications module 112 may be interrogated to obtain data or update the software programs on the electronic device 116.

Another feature of this invention is to enhance the scalability of the batteries by making the battery cells logically and/or physically removable and configurable so that battery capacity can be scaled on demand. Software 200 on the electronic device 116 allows the device 116 to communicate and share information with the adaptive energy management system 100 through the communication module 112. The intelligent adaptive energy management system software 200 on the electronic device 116 receives information relative to primary battery such as voltage and battery capacity and continuously monitors the status and charging mode of the internal battery. This information is then used by the system's 100 control module 108 to determine whether the secondary battery 102 should be used as the primary power source or remain in stand-by mode, as is further discussed below.

In some embodiments, historical data related to the primary battery cells and secondary battery cell(s) 102 is also stored. Historical data is used and compared to current conditions to facilitate real-time modification of energy management algorithms as well as post data analysis for more detailed energy management development. The actual data file structures are device and/or use specific. Needed portions of the data are maintained within the control module 108 and may be uploaded in parallel, or delayed send to the software 202 on the electronic device 116, or to an offline computer (not shown).

The electronic device 116, with the software 200, can also make requests of the intelligent adaptive energy system 100 based on its run or power level requirement status. The information can be used to dynamically update the software 200 on the electronic device 116. In this way the software learns and adapts to new and changing conditions. Further the intelligent adaptive energy management system 100 is constantly evaluated and fine-tuned. And, in the event or risk of catastrophic failure, the user is notified that the cell(s) 102 will stop providing power to the electronic device 116.

When the capacity of the internal battery is lower than a predetermined optimal value, or the computed optimal power level as determined by historical data evaluation by the battery system software 200, the software 200 instructs the control module 108 to issue the “turn on” command to the secondary battery 102. The “turn on” command is accomplished by the control module 108 instructing the DC/DC conversion module 114 to output the proper voltage and current to the electronic device 116.

When the capacity of the primary battery is higher than optimal values, the resident software 200 instructs the control module to issue the “turn off” command to the secondary battery. The “turn off” command is accomplished by the control module instructing the DC/DC conversion module 114 to turn off. Following the “turn off” sequence, the intelligent adaptive energy management system software will interrogate the primary battery to determine if the optimal charge level is being maintained for approximately three seconds. The intelligent adaptive energy management system software 200 will repeat this process for an algorithmic value of times to determine if the primary battery requires a more complex rotational charge method that would allow for refresh recharging between charge cycles. If the intelligent adaptive energy management system resident software 200 determines, based upon its historical data, that the primary battery in the electronic device 116 is not able to maintain optimal power levels following a rotational charge sequence, the intelligent adaptive energy management system resident software 200 will allow the primary battery to progress toward a full discharge. However, just prior to reaching full discharge, the resident software will shift power provision to the secondary battery 102 by instructing the control module 108 as detailed above.

This intelligent adaptive charging mode normally provides the primary battery with priority as a power supply for better efficiency. In addition, this adaptive charging mode can increase the life of the battery cell because the battery cell recovers better under “deep recharge” (recharge only after the battery capacity is consumed totally) when compared to “shallow recharge” (recharge whenever the battery capacity is not full). Moreover, the electronic device 116 can be powered longer by entering the power save mode when the external power is connected.

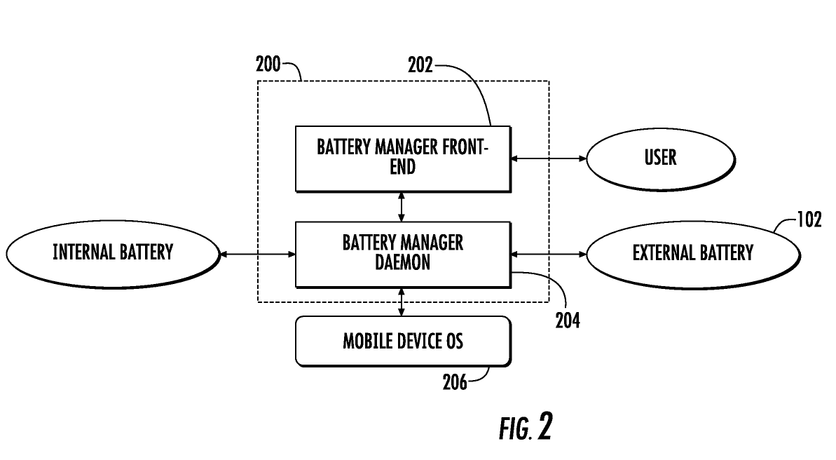

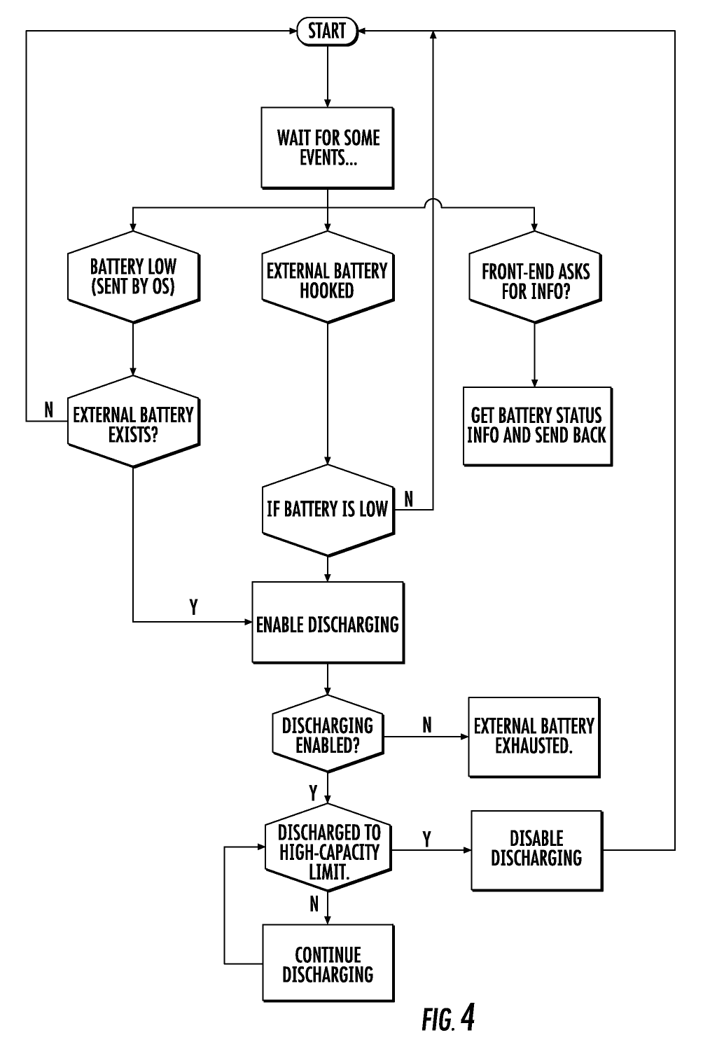

FIG. 4 discloses an embodiment of the logic used for the battery management by software 200. As shown, the system waits for some event such as, battery low signal sent by the mobile device operating system 206, attaching an external (secondary) battery 102 (in the external battery embodiment), or a request from the energy management software front end 202 (discussed below). If a low battery signal was sent by the mobile device operating system 206 the software 200 queries the system 100 for an external (secondary) battery 102. If an external (secondary) battery 102 exists, the system 100 enables the external (secondary) battery 102. If/when the external battery 102 is exhausted or the external battery 102 is in danger and about to shut down, the user is informed via capacity display 118 or via the display on the electronic device 116. If the battery manager front end 202 (shown in FIG. 2) asks for battery cell 102 data the software 200 sends a request signal to system 100 the system 100 retrieves the data requested and either keeps it for its own records or provides the data to the user for a user initiated request.

As shown in FIG. 2, the architecture of the battery manager software 200 on the electronic device 116 contains two parts: the battery manager daemon 204 and the battery manager front-end 202. The daemon 204 acts as the central hub of the entire charging system. It interacts with the mobile device operating system 206 to get the mobile device's 206 primary battery status information. The daemon 204 provides the mobile device 206 status information to the front-end 202 and processes the request sent by the front-end 202 such as “discharge enabling.” The daemon 204 also interacts with the external battery 102 to get its status information and to demand the external battery 102 to either enable or disable discharge. The user of the electronic device 116 (i.e. cellular phone) interacts with the battery manager front-end 202 to get the battery status information and/or issue certain commands.

The external battery manager software 200 provides two usage modes for the user to choose from: “manual mode” and “automatic mode”. The user can configure the external battery manager based upon their individual preference. In manual mode, the user turns on/off the external battery discharge module 106 explicitly through the discharge switch button of the external battery manager front-end interface 202. The daemon 204 will only get the battery status information when the user initializes the external battery manager front-end 202. Accordingly, in manual mode, it is up to the user to control the discharging process. In manual mode, the built in intelligence of the battery management module is not used.

In the automatic mode, the battery management module 106 controls the discharge process. The user may interrogate the external battery management front-end 202 to get the internal and external battery status information, however, when in this mode, the user cannot turn on/off the discharging process by hand.

In the automatic mode, the daemon 204 checks the status of the primary battery of the electronic device 116 periodically and verifies that the a secondary battery 102 is attached to the electronic device 116. The daemon 204 receives the primary battery charge percentage information and the voltage information of the primary battery internal algorithms. When the mobile device battery charge percentage is lower than a predetermined value, the communication module 112 will send the discharge enabling signal to the control module 108 to toggle its working stages between providing 5V voltage to electronic device 116 and not providing 5V voltage to electronic device 116. After daemon 204 sends out the signal, it will check again the primary battery status. If the status of the primary battery is changed to charging, the status of the secondary battery 102 will be recorded as discharging. If the status of the primary battery does not change, the status of the secondary battery 102 will be recorded as “none” and the daemon 204 will not check the battery status again. The daemon 204 will resume checking when the secondary battery 102 is recharged to normal condition and it sends the handshake hooking signal to mobile device 206. If the charging stage of the internal mobile device battery reaches a predefined value and is “charging”, the software will send another signal to the secondary battery 102. The secondary battery 102 receives the signal and toggles its working status to “off.” If the stage of the primary battery is “not charging” at any time before the internal battery reaches a predefined value, the secondary battery will be recorded as “none” and the daemon will not check the battery status again. The daemon 204 will resume its full operations when the secondary battery 102 is recharged to normal condition and it sends the handshake signal to electronic device 116.

The discharge enabling trigger limit and discharge disabling trigger limit may be pre-defined or firmware/software-defined with acceptable values greater than zero percent and less than 100%. The exact value of the two thresholds depends on the specific external battery cell specifications as well as the operational specifications of the DC/DC chip set(s).

Another feature of the invention relates to the techniques of charging and discharging of the primary and secondary cell(s) 102 of electronic device 116 in order to increase their life and efficiency. As shown in FIG. 1, charging/discharging switch 106 is in communication with controller 108 to control the rate at which the primary and secondary battery cell(s) 102 are charged and discharged. In the external battery embodiment, the secondary (external) batteries 102 of the adaptive energy management system 100 can be charged with or without the electronic device 116 attached. When the external adaptive energy management system 100 is connected with the electronic device 116, and an external charge is applied to charging module 110, the external charge will be used to charge the internal battery of the electronic device 116 and external battery cell(s) 102 simultaneously but the electronic device 116 has the higher priority to get the power from the charging source. The adaptive energy management system 100 may be adapted to receive a charge from mobile device's 116 standard wall charger or a normal USB port. When the voltage of the secondary cell(s) 102 is lower than a predetermined value (4.2V in some cell phone embodiments), the circuit will charge the external battery 102 with a predetermined constant current (500 mA or lower in some cell phone embodiments). In some cell phone embodiments, when the voltage of the external battery is equal to 4.2V, it will be charged with constant voltage of 4.25V till the charging current is lower than 15 mA.

In one embodiment, the adaptive energy management system 100 applies alternative charging techniques to increase the life and efficiency of the cell(s). In an external battery cell embodiment employing two or more secondary cells 102 as shown in FIG. 1, the first secondary cell may be fully charged before the second secondary cell begins receiving charge. In this way, the charging adaptor can provide enough power to charge the battery cells 102 and power the electronic device 116.

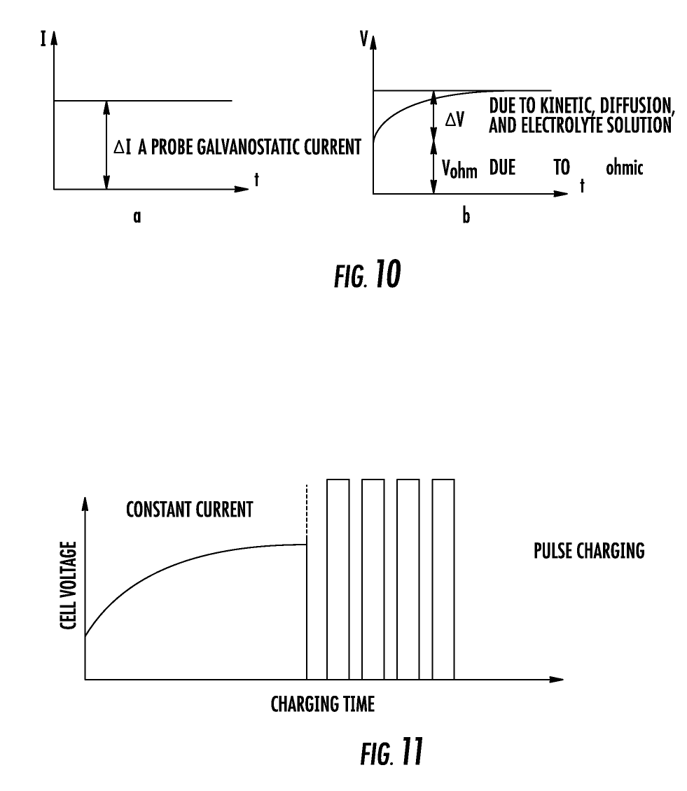

Pulse charging can charge batteries much faster than the traditional constant current followed by constant voltage charging method. In addition, it has been found that pulse charge methods do not cause additional negative side-effects and/or gradient concentration that are found in tradition methods. Some embodiments of this invention include fast pulse charge methods as shown in FIG. 11. The battery cell(s) 102 are charged by an intelligent adaptable (adjustable) frequency pulse methodology. The average voltage of the pulse is no more than maximum voltage that any specific battery cell 102 can tolerate, e.g. 4.25V. In some embodiments, while pulse charging takes place, the protection module 104 monitors cell characteristics such as temperature and deformation to help keep the secondary cell(s) 102 in a safe condition.

In another embodiment, the invention enhances safety and performance with its intelligent adaptable fast charge method. The intelligent adaptable fast charge method is based on the current condition of the cell(s) 102. After the constant current stage of charging, the battery is charged by an intelligent adaptive (adjustable) constant or variable voltage pulse. The charge pulse frequency and cycle are determined by the composite health status of the cell(s) 102. The composite health status information includes the electro-chemistry parameters calculated from galvanostatic pulse probing. Traditional battery status is monitored and/or determined by measuring individual cell voltage, composite voltage, current density, temperature, and shape of the battery cell. The fast charge method selected (constant or variable) uses these parameters in relation to stored historical data to decide on an optimized charge pulse frequency and voltage or current density.

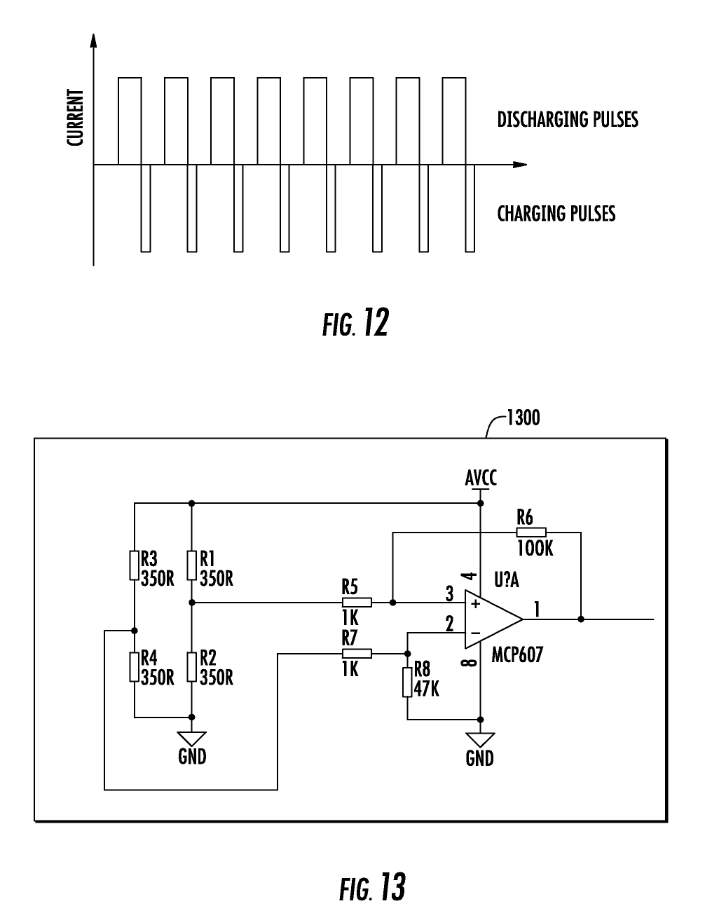

The method of charging the cell has an effect on the cells discharge. Traditionally the battery cell discharge characteristic is determined by the requirement of the outside electrical load. The continuous discharge of the battery cell 102 will increase polarization resistance. Polarization resistance arises due to the increase of the double layer effects and negatively impacts battery cell performance. The double layer effects will be reduced if the charge accumulation can be neutralized by either of two means. One way to reduce the charge accumulation is by the diffusion of the charge during the battery cell rest cycle. Another way to reduce the charge accumulation is to charge the battery cell by reverse current. Furthermore, diminishment of the double layer effect is accelerated by applying reverse charge current after a properly timed charging duty cycle. FIG. 12 illustrates the charge/discharge logic of an embodiment. The cell is discharged intermittently followed by a short-term reverse current charging pulse.

Controlling the discharge of the cell also has advantages such as increasing the useful life of the cell and sustaining its ability to hold a charge. Described above are the advantages of charging the cell intermittently. Combining the pulse charging method with the pulse discharge method allows the battery cell to derive appreciably more energy. During the battery cell discharge, the voltage of the cell can be divided into following different processes.
1. The total equilibrium voltage is the battery cell voltage when no current is flowing. The equilibrium voltage depends solely on the state-of-charge of the battery cell.
2. The kinetic over-potential (g-kinetic) is the over-potential for the charge transfer reaction at the positive and negative electrodes.
3. The diffusion over-potential reflects the concentration differences within the electrodes. Diffusion over-potentials in the electrodes are a result of the difference in composition of the electrode material at a position in the electrode very close to the back contact and at a position very close to the electrode/electrolyte solution interface.
4. Within the same electrolyte solution, a concentration gradient exists, giving rise to a Nernstian potential difference.

The first two processes cannot be changed as they are determined by battery cell charge status and battery cell reaction speed. However the last two processes (potential drops) can be modified and should be minimized as they are counter effective. As shown in FIG. 12, one embodiment of this invention comprises at least two battery cells (primary or secondary) that provide power for a fraction of cycle. Thus, each battery cell is equal to a pulse discharge. No disruption of output power supply to the electronic device 116 exists as the battery cells provide the power alternatively.

The above alternating discharge method is controlled by the control module 108 which determines the rate the cells 102 are discharged and, through the charge discharge switch 106 and converter 114, controls the pulse current amplitude as well as the adjustable frequency of the pluses. In an embodiment, the DC/DC converter 114 manages the conversion of the native voltage of battery cell 102 (typically 3V˜4.2V) to 5V power (or other voltage that is required by the mobile device). The control module 108 manages the DC/DC converter 114 by sending on/off requests. The charge discharge switch 106 selects the battery cell(s) 102 alternatively. This process is controlled by the device firmware installed in the control module 108. The frequency of selection may be adaptively changed, as required, to frequencies less than 1 Hz and up to 1 kHz. As a result of this discharge process, each battery cell 102 can recover from the undesired voltage accumulation on the double layer during its idle phase allowing more energy to be extracted.

FIG. 14 illustrates an embodiment of discharging method applied to the multi-cell battery system. Each of the battery cells can be used to generate power independently. Each battery cell is connected to the DC/DC converter 114 through a charge/discharging switch 106 which is controlled by the control module 108. To power the electronic device using the method disclosed in this embodiment, at least one cell must be actively discharging while one or more cells are inactive. The active and inactive cells in this discharging embodiment may include the secondary cells 102 and/or the primary cells. In use, as an active cell is powering the electronic device, the system 100 selects the subsequent active cell based on defined criteria. Next, the charge discharge switch 106 turns off the current active cell 102 while also turning on the selected cell 102. The inactive cell rests for some time (generally between 1 s and 1 ms) before it is allowed be selected again as the active cell. The system continuously cycles through the above process. There are many ways for selecting the next candidate battery cell. The simplest way is by selecting the next battery cell in order. Alternatively, the next battery cell could be the cell with the most capacity so that the battery cells would be kept in balance.

When the adaptive energy management system 100 is connected to the electronic device 116 and detached from any power source, the adaptive energy management system 100 will wait for the command issued by the electronic device 116 before discharging the system's 100 external batteries 102. In one cell phone embodiment, when the external battery manager software 202 in the electronic device 116 issues a signal to the adaptive energy management system 100 and the external battery cell(s) 102 voltage is higher than 3.0V, the system 100 will toggle its working stage between providing 5V voltage and not provide 5V voltage. When the voltage of the external battery cell(s) 102 is lower than the 3.0V, the system 100 will cut off the battery cell(s) 102 to protect them from over discharge.

Implementing the embodiments described above creates an adaptive energy management system 100 that is capable of handling hot plugging the secondary battery cells 102, i.e. the battery cells 102 can be added or removed on demand. As noted above with reference to other features, some embodiments of the hot plugging feature may allow the hot plugging of the electronic devices 116 primary batteries in addition to or instead of the hot plugging of the secondary batteries 102. The control module 108 probes the battery cell slots continuously. When an additional battery cell 102 is added, the control module 108 will notice the addition of the new battery cell 102 by checking the battery cell voltage. After the battery cell 102 has been added, the control module 108 adds it to the active battery cell pool for further action such as charging or discharging. On the other hand, when an existing battery cell 102 is removed, the control module 108 will notice the removal of the battery cell 102 by checking the battery cell 102 voltage. After the battery cell 102 has been removed, the control module 108 removes it from the active battery cell pool so the later charging or discharging process will not consider this battery cell 102.

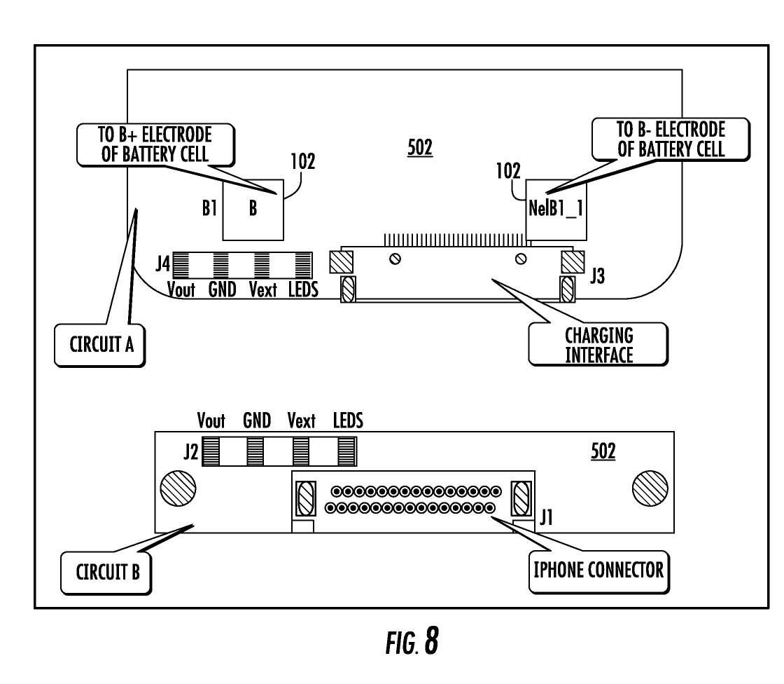

FIG. 9 provides an embodiment of the process of hot plug management of the battery cells. The system 100 checks the voltage of each battery slot. If the voltage is below certain value, the system 100 removes the corresponding battery cell from the battery cell pool. On the other hand, if the voltage is above certain value, then the system 100 adds the corresponding battery cell into the battery cell pool. The cell is now available for charging and discharging process, until the voltage falls below a certain predetermined value.

In some embodiments, the external battery cell (or cells) 102 is (are) combined with a protective case for the serviced device. Various embodiments of protective cases are shown in FIGS. 5, 6, and 7. The circuit 502 and battery cell(s) 102(a)(b) are covered by the protective case 600 made by leather, plastics or other suitable materials. The protective case 600 can come with an attachment clip 602 or without a clip. The electronic device 116 is powered and protected at the same time. The external battery cell(s) 102 can also be recharged together with the electronic device 116 inside, or separately without the need of the special external battery charger (i.e. the invention can be designed to use the adapter and/or charger supplied with the device it services).

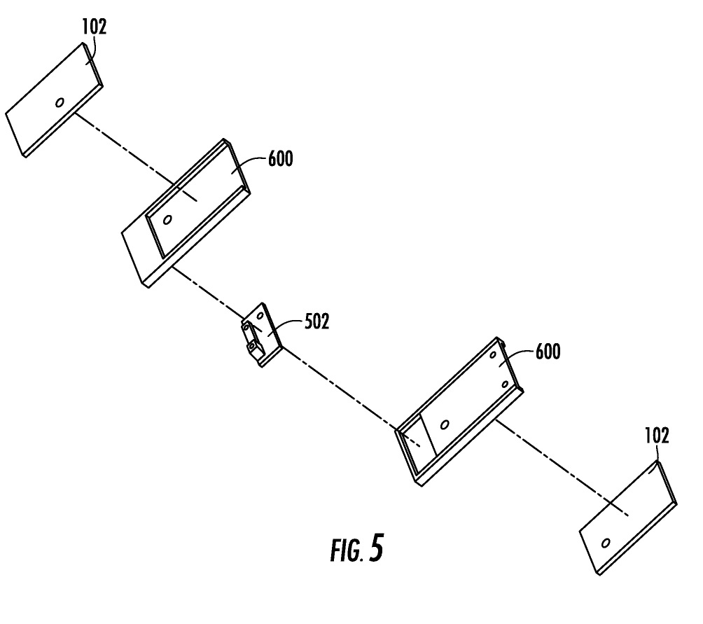

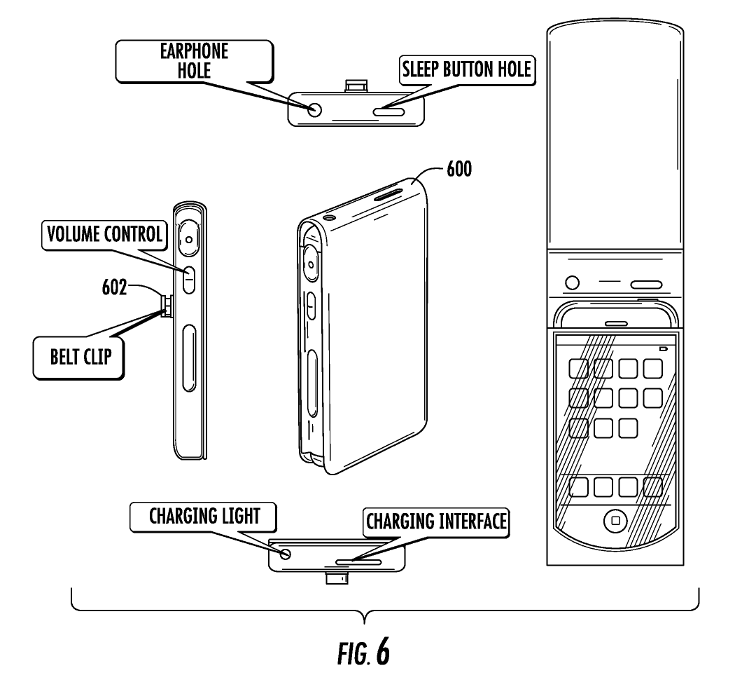

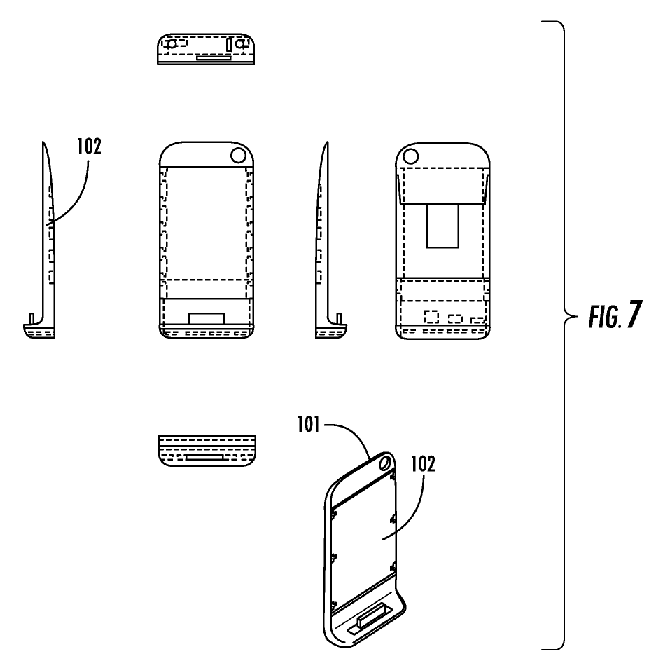

As shown in FIGS. 6-8, the single secondary cell 102 implementation of the intelligent adaptive external battery case 600 for mobile devices includes four parts: the plastic bracket 101, leather case 600, battery cell 102, and circuit 502. The bracket is used to support battery cell 102 and two circuit boards 502. In the embodiment shown in FIGS. 7-8, there are two circuit boards 502 and the battery cell 102 is welded to the circuit board.

The multiple secondary cell 102 intelligent adaptive external battery case is shown in FIG. 5. As shown in this embodiment, the battery cell(s) 102 can be installed on opposite sides of the case 600 and that the power output and input interfaces are located in the bottom side of the case 600. This embodiment provides more features than the single-cell intelligent adaptive external battery leather case for the mobile device. In this embodiment, the battery cell may be hot plugged, and up to two battery cells 102 may be installed.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. An intelligent energy power management system, comprising:
a host device;
a power pack adapted to selectively power said host device, said pack having a plurality of cells;
a protection module in communication with said cells;
a charge discharge switch for controlling power flow from said cells;
a control module in communication with said charge discharge switch and in communication with said cells;
a converter for changing the voltage produced by said cells in response to a command from said control module;
a communication module for facilitating communication between said control module and said host device.

2. The system of claim 1 further comprising a capacity display, wherein cell data is communicated from said control module for display to a user.

3. The system of claim 1 wherein said host device is a cellular telephone.

4. The system of claim 1 wherein the protection module further comprises a safety sensor adapted to receive data from said cells and communicate said data to said control module.

5. The system of claim 1 wherein said safety sensor is a temperature sensor for sensing temperature changes of said cells, wherein said control module isolates said cell if said temperature of said cell is greater than a predetermined value.

6. The system of claim 1 wherein said safety sensor senses shape changes of said cells, wherein said control module isolates said cell if said shape of said cell is outside of a predetermined range.

7. The system of claim 1 wherein said safety sensor is a voltage sensor adapted to detect voltage changes of said cells, wherein said controller isolates said cell if said voltage of said cell is outside of a predetermined range.

8. The system of claim 1 wherein said safety sensor is a current sensors for sensing current flow from said cells, wherein said controller isolates said cell if said current flow of said cell is outside of a predetermined range.

9. The system of claim 1 wherein said safety sensor is a current sensor for sensing current density of said cells, wherein said controller isolates said cell if said current density of said cell is outside of a predetermined range.

10. The system of claim 1 wherein said controller alternates the power flow among said cells based on conditions of said cells.

11. The system of claim 1 wherein control module further comprises a historical database, wherein data received from said sensors is stored in said database.

12. The system of claim 1 further comprising cells slots adapted to receive removable cells, wherein said control module probes empty cell slots and wherein when a cell is added said controller incorporates said cell into a cell database.

13. The system of claim 12 wherein said cell database removes a cell from said database in response to said cell being removed from said device.

14. The system of claim 1 wherein said cells are selectively in communication with said converter in response to a calculated rate by said control module.

15. The system of claim 14 wherein said calculated rate varies from 1 Hz to 1 kHz.

16. The system of claim 1 wherein communication to said host device includes status data wherein said host device triggers a warning action to a user in response to a warning generated by said control module.

17. The system of claim 1 wherein code on said host device is adapted to control said cell power flow in response to cell conditions received from said control module.

18. The system of claim 17 wherein code on said host device further comprises a front-end management code for facilitating communication between a user and a host device operating system.

19. The system of claim 18 wherein code on said host device further comprises a manager daemon for facilitating communication between said cells and said host device operating system.

20. A method of managing a batter system comprising the steps of:
monitoring the status of a host device's primary power cell;
checking for an external battery; and
enabling discharge of said external battery in response to a low value charge reading for the primary cell.

21. The method of claim 20 further comprising the step of warning a user of a predetermined low value reading for the primary cell.

22. The method of claim 20 further comprising the step of informing a user if the external battery is detected.

23. The method of claim 22 further comprising the step of responding to a charging signal by charging the battery internal to the host device.

24. A method of monitoring a battery system, comprising the steps of:
monitoring a plurality of battery cells in a battery pack; and
generating an alert signal if a battery cell characteristic is outside of a predetermined range.

25. The method of claim 24 wherein the step of monitoring further comprises the step of monitoring the voltage of the cells.

26. The method of claim 24 wherein the step of monitoring further comprises the step of monitoring the power flow of the cells.

27. The method of claim 26 further comprising the step of calculating a battery cell low discharge limit.

28. The method of claim 27 further comprising the step of isolating the cell in response to approaching said calculated low discharge limit.

29. The method of claim 24 wherein the step of monitoring further comprises the step of monitoring the current density of the cells.

30. The method of claim 24 further comprising the step of isolating the cell in response to said alert signal.

31. An intelligent battery pack comprising:
a plurality of cells; and
a circuit adapted to control said cell charging and discharging.

32. The intelligent battery pack of claim 31 further comprising a control module in communication with said battery cells.

33. The intelligent battery pack of claim 32 further comprising a charging module adapted to receive an external current flow and transferring said flow to said battery cells.

34. The intelligent battery pack of claim 33 further comprising a protection module for isolating said cells in response to a predetermined condition.

35. The intelligent battery pack of claim 34 further comprising a charging discharging module for controlling power flow to and from said cells, wherein said power flow is determined by said control module which control module communicates a command signal to said charging discharging module.

36. The intelligent battery pack of claim 35 further comprising a DC/DC converter module for changing the voltage received from said cells in response to a command signal from said control module.

37. The intelligent battery pack of claim 36 further comprising a communication module adapted to communicate with a host device, wherein data is transmitted from said control module to said host device.

38. The intelligent battery pack of claim 37 further comprising a capacity display for displaying battery pack data received from said control module to a user.

39. The intelligent battery pack of claim 31 further comprising safety sensors adapted to receive data from said cells and communicate said data to said control module.

40. The intelligent battery pack of claim 39 wherein said safety sensor further comprise temperature sensors for sensing temperature changes of said cells, wherein said controller isolates said cell if said temperature of said cell is greater than a predetermined threshold.

41. The intelligent battery pack of claim 39 wherein said safety sensor further comprise deformation sensors for sensing shape changes of said cells, wherein said controller isolates said cell if said shape of said cell is greater than a predetermined threshold.

42. The intelligent battery pack of claim 39 wherein said safety sensor further comprise voltage sensors for sensing voltage changes of said cells, wherein said controller isolates said cell if said voltage of said cell is greater than or less than a predetermined threshold.

43. The intelligent battery pack of claim 39 wherein said safety sensor further comprise current sensors for sensing current flow from said cells, wherein said controller isolates said cell if said current flow of said cell is greater than or less than a predetermined threshold.

44. The intelligent battery pack of claim 31 wherein said controller alternates the power flow among said cells based on conditions of said cells.

45. The intelligent battery pack of claim 31 wherein control module further comprises a historical database, wherein data received from said sensors is stored in said database.

46. The intelligent battery pack of claim 31 further comprising battery cells slots adapted to receive removable battery cells, wherein said control module probes empty cell slots and wherein when a battery cell is added said controller incorporates said cell into a battery cell database.

47. The intelligent battery pack of claim 31 wherein said control module further comprises a battery cell database, wherein said database removes a cell from said database in response to said cell being removed from said device.

48. The intelligent battery pack of claim 31 wherein said battery cells are selectively in communication with said converter in response to a calculated rate by said control module.

49. The system of claim 48 wherein said calculated rate varies from 1 Hz to 1 kHz.
